(19) United States
(12) Patent Application Publication
(10) Pub. No.: US 2022/0234912 A1
(43) Pub. Date: Jul. 28, 2022

(54) WATER REUSE SYSTEM FOR PHYSICAL AND MICROBIOLOGICAL DECONTAMINATION OF WATER

(71) Applicant: CMS Technology, Inc., Bridgewater, NJ (US)

(72) Inventors: Francis Dautreuil, Seabrook, TX (US); John Meccia, Ringoes, NJ (US)

(73) Assignee: CMS Technology, Inc., Bridgewater, NJ (US)

(21) Appl. No.: 17/596,965

(22) PCT Filed: Jul. 2, 2020
(86) PCT No.: PCT/US2020/040588

§ 371 Date: Dec. 22, 2021

Related U.S. Application Data
(60) Provisional application No. 62/870,246, filed on Jul. 3, 2019.

(51) Int. Cl. C02F 1/00; B01D 29/03; B01D 29/44; B01D 29/90; B01D 29/56; B01D 39/14

(52) U.S. Cl. CPC C02F 1/004; B01D 29/03; B01D 29/445; C02F 2103/22; B01D 29/908; B01D 29/56; B01D 39/14; B01D 29/904

(57) ABSTRACT

Provided are systems and methods to effect separation of solids from fluid runoff from poultry and produce treatment trains. The systems include separation panels that operate using the Coanda effect so as to effect separation of solids without the need for electricity or moving parts.

### RELATED APPLICATIONS

The present application claims priority to and the benefit of U.S. patent application No. 62/870,246, “Water Reuse System For Physical And Microbiological Decontamination Of Water” (filed Jul. 3, 2019), the entirety of which application is incorporated herein by reference for any and all purposes.

### TECHNICAL FIELD

The present disclosure relates to the field of solid-liquid separation and to the field of poultry and produce disinfection.

### BACKGROUND

On any given day, several billion chickens are processed at food processing facilities, and processing only a single chicken carcass can consume from about 3 to about 10 gallons of water. This results in a daily consumption of tens of billions of gallons of water every day by the poultry processing industry.

At present, food processors desire to recycle water to upstream applications, but such recycled water can contain a variety of undesired components, e.g., fat, tissue, fecal material, and pathogenic bacteria. Thus, in order to reuse water and prevent cross contamination, measures must be taken to reduce physical and microbiological contamination.

Existing reuse systems, however, cannot effectively separate out physical contaminates at the pertinent flow rates. In addition, existing systems frequently incorporate moving parts and consequently require a high degree of maintenance. Furthermore, current systems frequently do not incorporate a mechanism for controlling pathogenic cross contamination. Accordingly, there is a long-felt need for reducing the net consumption of water in poultry and other food processing facilities.

### SUMMARY

In meeting the described long-felt needs, the present disclosure provides systems that can continuously remove solid materials from wastewater streams at comparatively high flow rates and can do so using zero energy input.

The disclosed systems can utilize separation panels that operate by taking advantage of the so-called Coanda effect. Such screens offer an economical means for removing depress with little to no power input. The panels remove solids (e.g., debris) from a flow that passes over a wedge wire screen, with the wedge wires being oriented perpendicular to the flow direction. Individual wires can, in some embodiments, be tilted so that the leading edge of each wire projects into the flow, causing the member to shear a layer of the flow from the bottom of the water column at each slot opening. The screens are largely self-cleaning, with a high flow capacity and minimal need for routine maintenance.

A screen can be coated with an omniphobic and/or antimicrobial having a low coefficient of friction. This in turn permits rapid separation and reduced pathogenic bacteria and cross contamination in both the water and solids. Without being bound to any particular theory, the amount of antimicrobial treatment needed to decontaminate water processed according to the present disclosure can be reduced by, e.g., 50% as compared to traditional systems that utilize rotary drums or other motorized components. Without being bound to any particular theory, the disclosed technology can allow for recover of about 90% or greater of water that is introduced to the separation panels.

In one aspect, the present disclosure provides systems, comprising: a separation panel defining a longitudinal direction and a transverse direction, the transverse direction being essentially perpendicular to the longitudinal direction, the separation panel comprising a plurality of transversely oriented slot openings extending from a first surface of the separation panel to a second surface of the separation panel, a slot opening having a first width measured in the longitudinal direction at the first surface of the separation panel and a second width measured in the longitudinal direction at the second surface of the separation panel, the first width being less than the second width, the separation panel further comprising a plurality of transversal members extending in the transverse direction, the plurality of slot openings being defined between the plurality of transversal members; and a fluid delivery train, the fluid delivery train being in fluid communication with a treatment fluid of a treatment train configured to disinfect animal parts or produce, and the fluid delivery train being configured to deliver the treatment fluid to the first surface of the separation panel such that, by action of gravity, the treatment fluid flows in the longitudinal direction of the separation panel and flows across the slot openings of the first surface of the separation panel.

In another aspect, the present disclosure provides methods, the methods comprising: communicating a fluid that has contacted produce, animal parts, or both at a treatment location to a first surface of a separation panel, the separation panel defining a longitudinal direction and a transverse direction, the separation panel comprising a plurality of transversely oriented slot openings extending from the first surface of the separation panel to a second surface of the separation panel, a slot opening having a first width measured in the longitudinal direction at the first surface of the separation panel and a second width measured in the longitudinal direction at the second surface of the separation panel, the first width being less than the second width, the separation panel further comprising a plurality of transversal members extending in the transverse direction, the plurality of slot openings being defined between the plurality of transversal members, the communicating being performed under such conditions that, by action of gravity, the fluid flows along the panel in the longitudinal direction of the separation panel and the panel effects separation of solid matter from the fluid to as to separate the fluid into a solids fraction and a fluid fraction, the fluid fraction flowing through at least some of the plurality of slot openings; collecting one or both of the fluid fraction and the solids fraction.

Also provided are systems, the systems comprising: a separation panel defining a longitudinal direction and a transverse direction, the separation panel comprising a plurality of transversely oriented slots extending from a first surface of the separation panel to a second surface of the separation panel, the separation panel further comprising a plurality of transversal members extending in the transverse direction, the plurality of slots being defined between the plurality of transversal members; a fluid delivery train, the fluid delivery train being in fluid communication with a treatment train configured to disinfect animal parts, produce, or both, the fluid delivery train being configured to deliver a fluid to the first surface of the separation panel such that, by action of gravity, the fluid flows along the panel in the longitudinal direction of the separation panel, and the transversal members being configured to effect conveyance of the fluid through the slots by Coanda effect.

Further provided are methods, the methods comprising: communicating a fluid that has contacted produce, animal parts, or both at a treatment location to a first surface of a separation panel, the separation panel defining a longitudinal direction and a transverse direction, the separation panel comprising a plurality of transversely oriented slots extending from a first surface of the separation panel to a second surface of the separation panel, the separation panel further comprising a plurality of transversal members extending in the transverse direction, the plurality of slots being defined between the plurality of transversal members, the communicating being performed under such conditions that, by action of gravity, the fluid flows along the panel in the longitudinal direction of the separation panel and the separation panel effects separation of solid matter from the fluid to as to separate the fluid into a solids fraction and a fluid fraction, the fluid fraction flowing through at least some of the plurality of slot openings and the fluid fraction being conveyed through the slots by Coanda effect; and collecting one or both of the fluid fraction and the solids fraction.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides a cutaway view of an exemplary separation panel according to the present disclosure;

FIG. 2 provides a cutaway view of a system according to the present disclosure;

FIG. 3 provides cross-sectional views of exemplary members used in the disclosed technology;

FIG. 4 provides a cutaway view of a Coanda effect panel showing the various parameters of the transverse members of the panel; and

FIG. 5 provides an overview of an exemplary system according to the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

### FIGURES

The appended figures provide non-limiting illustrations of the disclosed technology.

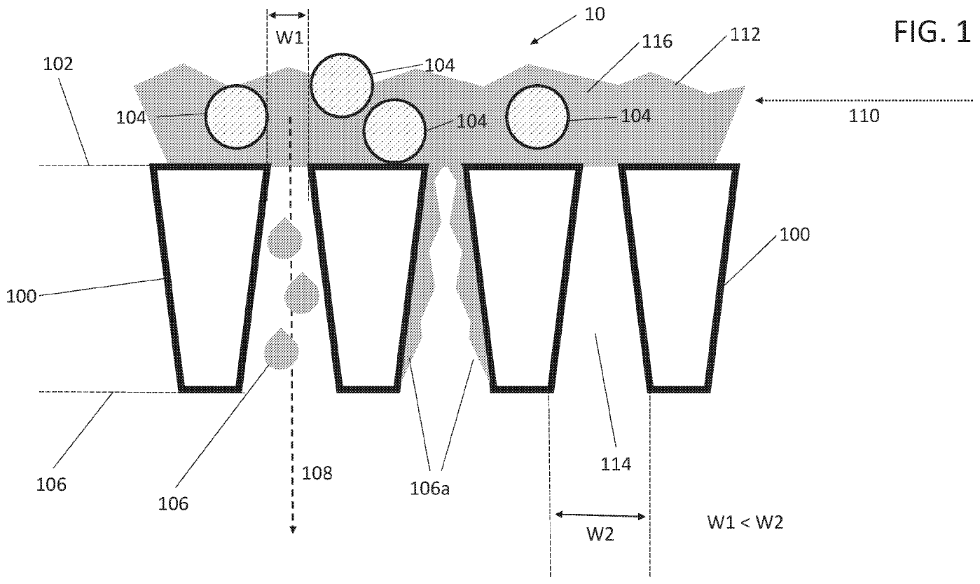

FIG. 1 provides a cutaway view of an exemplary separation panel 10 according to the present disclosure. As shown, separation panel 10 can include a plurality of members 100 (shown in cross-section in FIG. 1). Members 100 can extend in a transverse direction relative to the longitudinal direction 110 of the separation panel 10.

A separation panel can define a first surface 102 and a second surface 106, with channels (also termed slot openings) 114 defined between members 100. As shown, a slot opening has a width W1 defined at the first surface 102 of separation panel 10 and has a width W2 defined at the second surface 106 of separation panel 10. (Width W1 and width W2 can be measured in the longitudinal direction 110.) As shown, width W1 is suitably less than width W2. The ratio of W1 to W2 can be, e.g., from 1:100 to 1:1.0001, from 1:10 to 1:1.001, from 1:5 to 1:1.01, or even from 1:3 to 1:1.1.

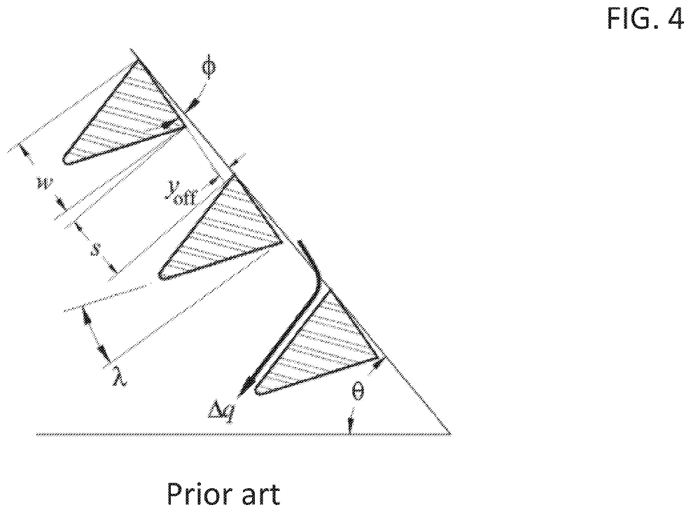

Although not shown in FIG. 1, individual members can, in some embodiments, be tilted so that an edge of the member projects into the flowing fluid, causing the member to shear a layer of the flow at the slot opening. This is shown in FIG. 4, which illustrates that an edge of a transverse member can be tilted by an angle φ so that an edge of the member is offset by a distance (y_{off}) and projects into the fluid flow (not shown in FIG. 4).

As shown in FIG. 1, a fluid 112 can be flowed along the first surface 102 of separation panel 10. The fluid 112 can be flowed in the longitudinal direction 110 defined by separation panel 10. Fluid 112 can include a liquid 116 and solid(s) 104. As shown, width W1 can be such that solid 104 can not pass through width W1 while liquid 116 can pass through width W1, as shown by drops 106. It should be understood that drops 106 are used for illustrative purposes only, as liquid 116 can (without being bound to any particular theory) be drawn or otherwise encouraged into slot opening 114; liquid 116 can flow along a surface of member 114 as shown by surface flows 106a (not to scale). Again without being bound to any particular theory, fluid can be drawn along a surface of member 114 by way of the so-called Coanda effect.

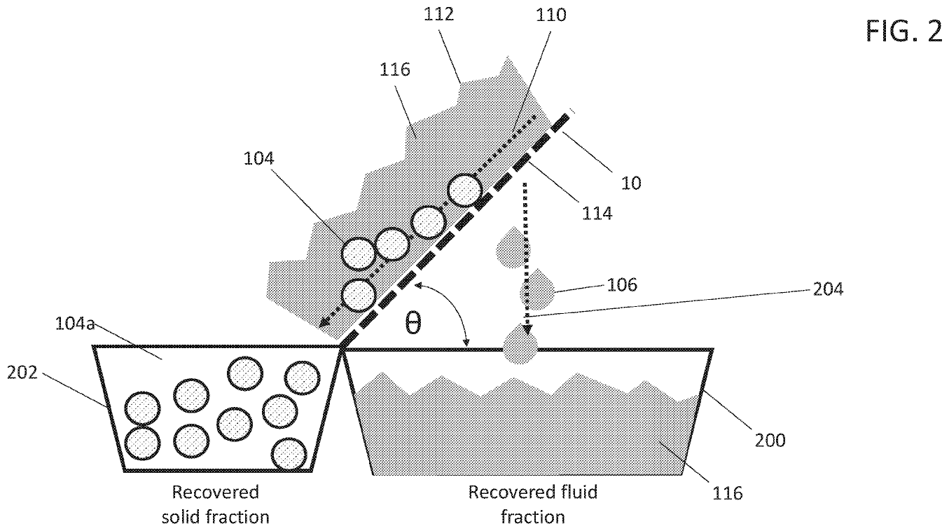

FIG. 2 provides a cutaway view of the operation of a system according to the present disclosure. As shown, fluid 112 (e.g., a fluid that comprises water and poultry solids) is flowed in a direction 110 along separation panel 10. Liquid 116 (shown by droplet 106, moving in direction 204, which direction 204 can be in the direction of gravity) passes into slot openings 114 of panel 10, while solid 104 is not able to pass through slot openings 114. Catch vessel 200 can be used to collect liquid 116 that passes through slot openings 114 of panel 10. Solid 104, which does not pass through slot openings 114, is collected in vessel 202.

As shown in FIG. 2, panel 10 can be inclined at angle θ relative to the horizontal. Angle θ can be from about 1 to about 90 degrees, from about 10 to about 80 degrees, from about 20 to about 70 degrees, from about 30 to about 60 degrees, or even from about 40 to about 50 degrees. Angles of from about 50 to about 75 degrees are considered especially suitable, although other angles can be used.

A system according to the present disclosure can operate without any moving parts and/or power input. As one example, a fluid can be introduced at the upper portion of an inclined separation panel, and by action of gravity, the fluid flows downhill along the panel, where the slot openings admit liquid but not solids that are entrained or otherwise carried along with the liquid. Gravity in turn acts to encourage the liquid into a recovery vessel, and the solids—which have not been admitted into the slot openings of the separation panel—are also carried by gravity to a collection area. Thus, as explained—and as shown in FIG. 2—the disclosed systems can operate to effect solids separation from fluid under only the action of gravity.

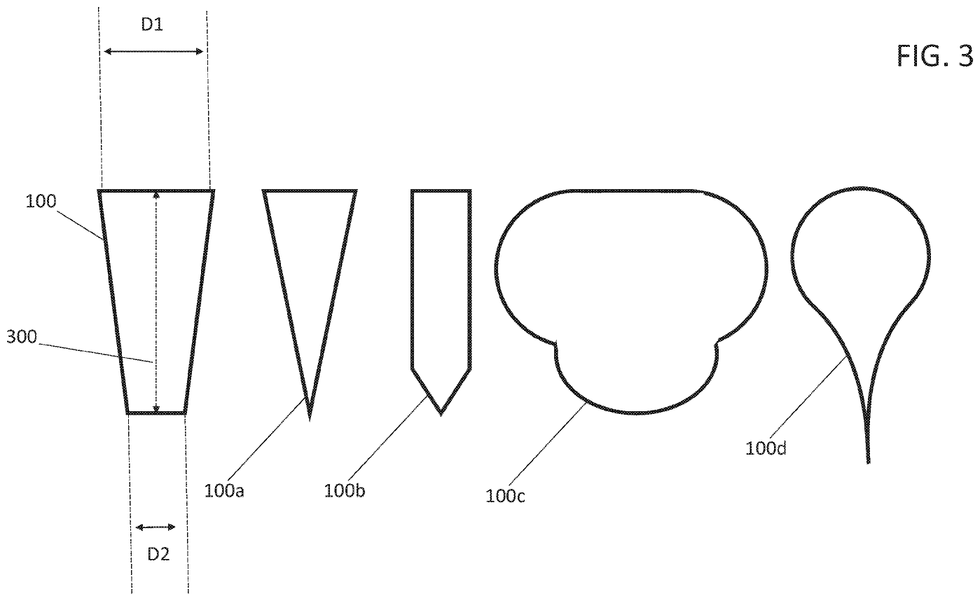

FIG. 3 provides exemplary, non-limiting cross-sectional profiles for members useful in the disclosed technology. As shown, a member may have a profile that is characterized as a truncated cone, as shown by 100. A member can also have a profile that is triangular in nature, as shown by 100a. A member can also have a chisel-type profile, as shown by 100b; other polygonal profiles are also suitable. A member can also have a profile that is tri-lobular in profile, as shown by 100c. A member can also have a teardrop or otherwise tapered profile, as shown by 100d. As exemplified, a member can define a thickness 300 and define a width D2 at one end of thickness 300 and a width D1 at the other end of thickness 300, with D1 suitably being greater than D2. It should be understood that width D2 can even be a point, e.g., as shown in 100d. A member can have a non-constant width along thickness 300.

FIG. 4 provides a cutaway view of an exemplary Coanda effect panel, illustrating the various panel parameters. As shown, an edge of a transverse member can be tilted by an angle φ so that an edge of the member is offset by a distance (y_{off}) from a line along the surface of the panel and projects into the fluid flow (not shown in FIG. 4). A slot opening can define a width s, and a transverse member can define a width w. A transverse member can be tapered, with the tapering comprising surfaces that are angled at an angle λ from a line perpendicular to a surface of the panel. The overall panel can be angled by an angle θ from the horizontal; a discharge Δq of fluid passing through the slot opening is also shown.

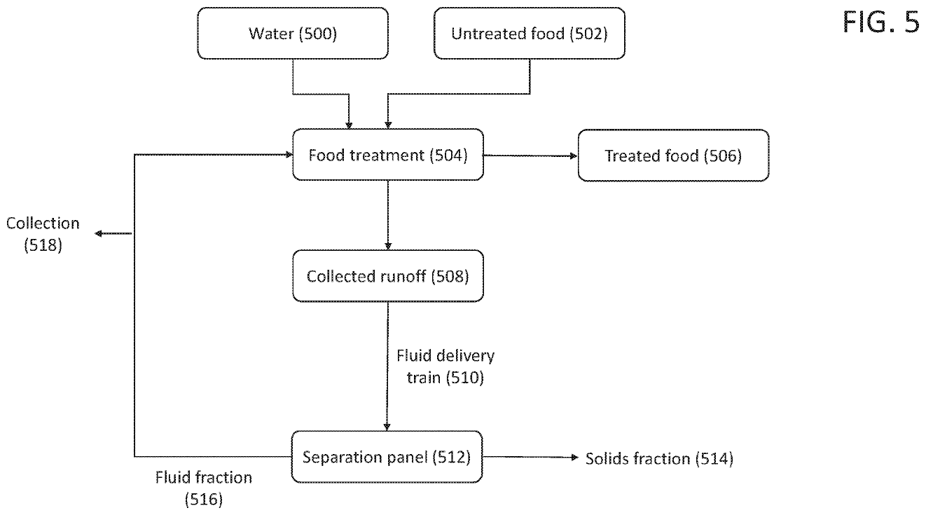

FIG. 5 provides an exemplary, non-limiting view of a system according to the present disclosure. As shown, produce treatment train 504 can receive water 500 and untreated food 502 (e.g., untreated poultry parts). Following treatment at treatment train 504, treated food 506 is collected for further processing, e.g., packaging and sale.

Runoff 508 can be collected and then, via fluid delivery train 510, delivered to separation panel 512. Suitable separation panels are described elsewhere herein; such panels can comprise wedge wire members and operate via the Coanda effect. After being flowed over separation panel 512, runoff 508 is separated into fluid fraction 516 and solids fraction 514.

Solids fraction 514 can be further processed (e.g., rendered, combusted) or even discarded. Fluid fraction 516 can be collected (518) and (at least partially) discarded; fluid fraction 516 can also be returned/recycled to food treatment train 504. Before being communicated to food treatment train 504, fluid fraction 516 can be filtered or otherwise processed (e.g., via application of one or more antimicrobial agents). Fluid fraction 516 can also be processed (e.g., via application of an antimicrobial agent) before being discarded.

### Embodiments

The following embodiments are illustrative only and do not serve to limit the scope of the present disclosure or the appended claims.

Embodiment 1. A system, comprising: a separation panel defining a longitudinal direction and a transverse direction, the transverse direction being essentially perpendicular to the longitudinal direction, the separation panel comprising a plurality of transversely oriented slot openings extending from a first surface of the separation panel to a second surface of the separation panel, a slot opening having a first width measured in the longitudinal direction at the first surface of the separation panel and a second width measured in the longitudinal direction at the second surface of the separation panel, the first width being less than the second width, the separation panel further comprising a plurality of transversal members extending in the transverse direction, the plurality of slot openings being defined between the plurality of transversal members; and a fluid delivery train, the fluid delivery train being in fluid communication with a treatment fluid of a treatment train configured to disinfect animal parts or produce, and the fluid delivery train being configured to deliver the treatment fluid to the first surface of the separation panel such that, by action of gravity, the treatment fluid flows in the longitudinal direction of the separation panel and flows across the slot openings of the first surface of the separation panel.

A slot can be linear in nature (as characterized along the transverse direction), but this is not a requirement, as a slot can include one or more curved portions.

A fluid delivery train can include, e.g., a sprayer, a nozzle, a manifold, a trough, and the like, as essentially any conduit capable of carrying fluid can be used in the fluid delivery train. A fluid delivery train can be, e.g., configured to include pipes or other conduits that are mounted overhead or above the separation panel in order that gravity can be used to carry fluid down from the fluid delivery train onto the separation panel. In this way, the disclosed systems can be free or essentially free of any powered components (such as pumps) and can operate entirely based on gravity. This allows the disclosed systems to operate by using less electricity than existing systems, as well as to operate without the need for mechanical components with moving parts, thereby reducing the need for ongoing maintenance.

A system according to the present disclosure can include a sprayer used to “hose off” any excess solids that may accumulate atop the separation panel. A spray can be located behind the panel so as to clean out the slot openings of the panel; this can help to reduce or eliminate “blinding” of the panel. A system according to the present disclosure can also optionally include one or more vibration or oscillation motors, which can be used to vibrate a separation panel.

Embodiment 2. The system of Embodiment 1, wherein at least some of the plurality of transversal members comprise an oleophobic surface thereon. Exemplary oleophobic surface materials include, e.g., materials characterized by having a n-hexadecane contact angle of from about 60 to about 90 degrees. Materials having a contact angle of from about 70 to about 90 degrees (or even above 90 degrees) for ethylene glycol are also considered oleophobic. (Poly)fluoropolymers are one exemplary oleophobic material; other oleophobic coating materials will be known to those of ordinary skill in the art. It should also be understood that the oleophobic surface can comprise one or more surface features, e.g., micropillars, posts, and the like.

Embodiment 3. The system of any of Embodiments 1-2, wherein at least some of the plurality of transversal members comprise an omniphobic surface thereon. (Poly)fluoropolymers can be used as omniphobic surfaces. It should also be understood that the omniphobic surface can comprise one or more surface features, e.g., micropillars, posts, and the like.

Embodiment 4. The system of any one of claims 1-3, wherein at least some of the plurality of transversal members comprise an antimicrobial surface thereon. Antimicrobial materials include, e.g., silver, copper, an organosilane, a quaternary ammonium, and the like.

Embodiment 5. The system of any one of Embodiments 1-4, wherein the plurality of transversal members define a tapered cross-sectional profile.

Embodiment 6. The system of any one of Embodiments 1-5, wherein the plurality of transversal members define a cross-sectional profile characterized as triangular, truncated triangular, trilobular, elliptical, or any combination thereof. Exemplary cross-sections are provided in FIG. 3.

Embodiment 7. The system of any one of Embodiments 1-6, wherein the fluid delivery train is in fluid communication with a treatment train configured to disinfect animal parts, e.g., poultry and/or other meat processing. A treatment train can include, e.g., spray cabinets, dip tanks, and the like. The system can receive fluid used (e.g., disinfection fluid) to disinfect the animal parts after the fluid has been applied to the animal parts.

Embodiment 8. The system of any one of Embodiments 1-6, wherein the fluid delivery train is in fluid communication with a treatment train configured to disinfect produce.

Embodiment 9. The system of any one of Embodiments 1-8, wherein a slot opening defines a width of from about 0.3 mm to about 5 mm, as measured at the first surface of the separation panel.

Embodiment 10. The system of any one of Embodiments 1-9, wherein the fluid delivery train comprises a weir, a manifold, a bar, a distribution channel, or any combination thereof. Without being bound to any particular theory or embodiment, such a component (e.g., manifold) can be used to spread fluid across the width of the separation panel so that the entire width of the panel is used to effect separation.

Embodiment 11. The system of any one of Embodiments 1-10, further comprising a second separation panel in fluid communication with the separation panel, the second separation panel defining a longitudinal direction and a transverse direction, the second separation panel comprising a plurality of transversely oriented second slot openings extending from a first surface of the second separation panel to a second surface of the second separation panel, a second slot opening having a first width measured in the longitudinal direction at the first surface of the second separation panel and a second width measured in the longitudinal direction at the second surface of the separation panel, the first width being less than the second width, the second separation panel further comprising a plurality of second transversal members extending in the transverse direction, the plurality of second slot openings being defined between the plurality of second transversal members.

The second separation panel differ from the separation panel in terms of, e.g., slot opening width (at the first and/or second surfaces of the second separation panel). The second separation panel can be used to effect a finer separation than the first separation panel, e.g., to separate solids that pass through the slot openings of the first separation panel from the fluid in which the solids are entrained. Without being bound to any particular theory, a user can arrange separation panels in a staged fashion such that a system according to the present disclosure includes a plurality of separation stages, with each stage comprising one or more separation panels.

Although the disclosed systems can operate without electrical input, a system according to the present disclosure can include one or more motorized components. For example, a system according to the present disclosure can include a rotary drum (e.g., a rotary vacuum drum filter), vibration table, and the like. The motorized component can be in fluid communication with a separation panel.

Embodiment 12. The system of Embodiment 11, wherein at least some of the plurality of second transversal members comprise an oleophobic surface thereon. Suitable oleophobic surfaces are described elsewhere herein.

Embodiment 13. The system of any of Embodiments 11-12, wherein at least some of the plurality of second transversal members comprise an omniphobic surface thereon.

Embodiment 14. The system of any one of Embodiments 11-13, wherein at least some of the plurality of second transversal members comprise an antimicrobial surface thereon.

Embodiment 15. A method, comprising: communicating a fluid that has contacted produce, animal parts, or both at a treatment location to a first surface of a separation panel, the separation panel defining a longitudinal direction and a transverse direction, the separation panel comprising a plurality of transversely oriented slot openings extending from the first surface of the separation panel to a second surface of the separation panel, a slot opening having a first width measured in the longitudinal direction at the first surface of the separation panel and a second width measured in the longitudinal direction at the second surface of the separation panel, the first width being less than the second width, the separation panel further comprising a plurality of transversal members extending in the transverse direction, the plurality of slot openings being defined between the plurality of transversal members, the communicating being performed under such conditions that, by action of gravity, the fluid flows along the panel in the longitudinal direction of the separation panel and the panel effects separation of solid matter from the fluid to as to separate the fluid into a solids fraction and a fluid fraction, the fluid fraction flowing through at least some of the plurality of slot openings; collecting one or both of the fluid fraction and the solids fraction.

Embodiment 16. The method of Embodiment 15, wherein the transversal members comprise one or more of an oleophobic coating, an omniphobic coating, or an antibacterial coating

Embodiment 17. The method of any one of Embodiments 15-16, further comprising communicating at least some of the fluid fraction to the treatment location.

Embodiment 18. A system, comprising: a separation panel defining a longitudinal direction and a transverse direction, the separation panel comprising a plurality of transversely oriented slots extending from a first surface of the separation panel to a second surface of the separation panel, the separation panel further comprising a plurality of transversal members extending in the transverse direction, the plurality of slots being defined between the plurality of transversal members; a fluid delivery train, the fluid delivery train being in fluid communication with a treatment train configured to disinfect animal parts, produce, or both, the fluid delivery train being configured to deliver a fluid to the first surface of the separation panel such that, by action of gravity, the fluid flows along the panel in the longitudinal direction of the separation panel, and the transversal members being configured to effect conveyance of the fluid through the slots by Coanda effect.

Embodiment 19. The system of Embodiment 18, wherein the transversal members comprise one or more of an oleophobic surface, an omniphobic surface, or an antibacterial surface.

Embodiment 20. A method, comprising: communicating a fluid that has contacted produce, animal parts, or both at a treatment location to a first surface of a separation panel, the separation panel defining a longitudinal direction and a transverse direction, the separation panel comprising a plurality of transversely oriented slots extending from a first surface of the separation panel to a second surface of the separation panel, the separation panel further comprising a plurality of transversal members extending in the transverse direction, the plurality of slots being defined between the plurality of transversal members, the communicating being performed under such conditions that, by action of gravity, the fluid flows along the panel in the longitudinal direction of the separation panel and the separation panel effects separation of solid matter from the fluid to as to separate the fluid into a solids fraction and a fluid fraction, the fluid fraction flowing through at least some of the plurality of slot openings and the fluid fraction being conveyed through the slots by Coanda effect; and collecting one or both of the fluid fraction and the solids fraction.

It should be understood that the disclosed technology can also include further treatment and/or processing of solids (e.g., debris, particulate) and fluid fractions that are recovered (e.g., elements 104a and 116 in FIG. 2). As one example, solids material can be further processed (e.g., rendering fat in the solids fraction) and then the results of that further processing can be sold, consumed, or otherwise utilized.

Likewise, fluid that is collected can be recycled back to a produce and/or animal parts processing stage. Such fluid can be recycled in its as-collected form; the fluid can also be further processed (e.g., via filtration, via treatment with one or more antimicrobial agents) before being sent to the produce and/or animal parts processing stage.

1. A system, comprising:
a separation panel defining a longitudinal direction and a transverse direction, the transverse direction being essentially perpendicular to the longitudinal direction,
the separation panel comprising a plurality of transversely oriented slot openings extending from a first surface of the separation panel to a second surface of the separation panel,
a slot opening having a first width measured in the longitudinal direction at the first surface of the separation panel and a second width measured in the longitudinal direction at the second surface of the separation panel, the first width being less than the second width,
the separation panel further comprising a plurality of transversal members extending in the transverse direction, the plurality of slot openings being defined between the plurality of transversal members; and
a fluid delivery train,
the fluid delivery train being in fluid communication with a treatment fluid of a treatment train configured to disinfect animal parts or produce, and
the fluid delivery train being configured to deliver the treatment fluid to the first surface of the separation panel such that, by action of gravity, the treatment fluid flows in the longitudinal direction of the separation panel and flows across the slot openings of the first surface of the separation panel.

2. The system of claim 1, wherein at least some of the plurality of transversal members comprise an oleophobic surface thereon.

3. The system of claim 1, wherein at least some of the plurality of transversal members comprise an omniphobic surface thereon.

4. The system of claim 1, wherein at least some of the plurality of transversal members comprise an antimicrobial surface thereon.

5. The system of claim 1, wherein the plurality of transversal members define a tapered cross-sectional profile.

6. The system of claim 1, wherein the plurality of transversal members define a cross-sectional profile characterized as triangular, truncated triangular, trilobular, elliptical, or any combination thereof.

7. The system of claim 1, wherein the fluid delivery train is in fluid communication with a treatment train configured to disinfect animal parts.

8. The system of claim 1, wherein the fluid delivery train is in fluid communication with a treatment train configured to disinfect produce.

9. The system of claim 1, wherein a slot opening defines a width of from about 0.3 mm to about 5 mm, measured at the first surface of the separation panel.

10. The system of claim 1, wherein the fluid delivery train comprises a weir, a manifold, a bar, a distribution channel, or any combination thereof.

11. The system of claim 1, further comprising a second separation panel in fluid communication with the separation panel,
the second separation panel defining a longitudinal direction and a transverse direction,
the second separation panel comprising a plurality of transversely oriented second slot openings extending from a first surface of the second separation panel to a second surface of the second separation panel,
a second slot opening having a first width measured in the longitudinal direction at the first surface of the second separation panel and a second width measured in the longitudinal direction at the second surface of the separation panel, the first width being less than the second width,
the second separation panel further comprising a plurality of second transversal members extending in the transverse direction,
the plurality of second slot openings being defined between the plurality of second transversal members.

12. The system of claim 11, wherein at least some of the plurality of second transversal members comprise an oleophobic coating disposed thereon.

13. The system of claim 11, wherein at least some of the plurality of second transversal members comprise an omniphobic coating disposed thereon.

14. The system of claim 11, wherein at least some of the plurality of second transversal members comprise an antimicrobial coating disposed thereon.

15. A method, comprising:
communicating a fluid that has contacted produce, animal parts, or both at a treatment location to a first surface of a separation panel,
the separation panel defining a longitudinal direction and a transverse direction,
the separation panel comprising a plurality of transversely oriented slot openings extending from the first surface of the separation panel to a second surface of the separation panel,
a slot opening having a first width measured in the longitudinal direction at the first surface of the separation panel and a second width measured in the longitudinal direction at the second surface of the separation panel, the first width being less than the second width,
the separation panel further comprising a plurality of transversal members extending in the transverse direction, the plurality of slot openings being defined between the plurality of transversal members,
the communicating being performed under such conditions that, by action of gravity, the fluid flows along the panel in the longitudinal direction of the separation panel and the panel effects separation of solid matter (e.g., fat, particulate, tissue) from the fluid to as to separate the fluid into a solids fraction and a fluid fraction, the fluid fraction flowing through at least some of the plurality of slot openings;
collecting one or both of the fluid fraction and the solids fraction.

16. The method of claim 15, wherein the transversal members comprise one or more of an oleophobic coating, an omniphobic coating, or an antibacterial coating,

17. The method of claim 15, further comprising communicating at least some of the fluid fraction to the treatment location.

18. A system, comprising:
a separation panel defining a longitudinal direction and a transverse direction,
the separation panel comprising a plurality of transversely oriented slots extending from a first surface of the separation panel to a second surface of the separation panel,
the separation panel further comprising a plurality of transversal members extending in the transverse direction, the plurality of slots being defined between the plurality of transversal members;
a fluid delivery train,
the fluid delivery train being in fluid communication with a treatment train configured to disinfect animal parts, produce, or both,
the fluid delivery train being configured to deliver a fluid to the first surface of the separation panel such that, by action of gravity, the fluid flows along the panel in the longitudinal direction of the separation panel, and
the transversal members being configured to effect conveyance of the fluid through the slots by Coanda effect.

19. The system of claim 18, wherein the transversal members comprise one or more of an oleophobic coating, an omniphobic coating, or an antibacterial coating.

20. A method, comprising:
communicating a fluid that has contacted produce, animal parts, or both at a treatment location to a first surface of a separation panel,
the separation panel defining a longitudinal direction and a transverse direction,
the separation panel comprising a plurality of transversely oriented slots extending from a first surface of the separation panel to a second surface of the separation panel,
the separation panel further comprising a plurality of transversal members extending in the transverse direction, the plurality of slots being defined between the plurality of transversal members,
the communicating being performed under such conditions that, by action of gravity, the fluid flows along the panel in the longitudinal direction of the separation panel and the separation panel effects separation of solid matter from the fluid to as to separate the fluid into a solids fraction and a fluid fraction,
the fluid fraction flowing through at least some of the plurality of slot openings and the fluid fraction being conveyed through the slots by Coanda effect; and
collecting one or both of the fluid fraction and the solids fraction.
